(19) United States
(12) Patent Application Publication
(10) Pub. No.: US 2012/0307299 A1
(43) Pub. Date: Dec. 6, 2012

(54) IMAGE INPUT SYSTEM, INFORMATION PROCESSING APPARATUS, CONTROL METHOD THEREFOR, AND STORAGE MEDIUM STORING CONTROL PROGRAM THEREFOR

(75) Inventor: Koji Inose, Saitama-shi (JP)

(73) Assignee: CANON KABUSHIKI KAISHA, Tokyo (JP)

(21) Appl. No.: 13/483,173

(22) Filed: May 30, 2012

(30) Foreign Application Priority Data
Jun. 1, 2011 (JP) 2011-123641

(51) Int. Cl. G06K 15/02

(52) U.S. Cl. 358/1.15

(57) ABSTRACT

An image input system that is capable of applying to the cloud computing system and of reducing user's load in selecting an image input apparatus used. An information processing apparatus communicates with a server via the Internet and a wireless communication network. A first image input apparatus is directly connected to the information processing apparatus. Second image input apparatuses are connected to the information processing apparatus via a local network. The server transmits a search message for searching an image input apparatus to the information processing apparatus. The information processing apparatus determines whether the first image input apparatus is usable in response to reception of the search message from the server, and selects the first image input apparatus without searching for the second image input apparatuses and notifies the server of the selection when it is determined that the first image input apparatus is usable.

### BACKGROUND OF THE INVENTION

1. Field of the Invention

The present invention relates to an image input system that transmits image information generated by an image input apparatus to a server via an information processing apparatus and stores it, the information processing apparatus concerned, a control method therefor, and a storage medium storing a control program therefor.

2. Description of the Related Art

In order to select an apparatus used from a plurality of peripheral apparatuses connected to an information processing apparatus through a network, a selecting operation by a user is needed in general. On the other hand, Japanese Laid-Open Patent Publication (Kokai) No. 2009-278387 (JP 2009-278387A) discloses a technique for reducing user's load in selecting an apparatus in an environment where a server is connected to a plurality of image forming apparatuses through a network. In this technique, when a user instructs printing by an image forming apparatus that is provided with an operating function, the server automatically sets up this apparatus as an apparatus that is used to print. When the image forming apparatus concerned cannot print immediately, the server searches for another image forming apparatus and make the retrieved apparatus execute a print job instead.

However, since the system disclosed in the above-mentioned publication needs to locate the server in the same local network as the image forming apparatuses in order to query the apparatuses about their printing abilities, the system cannot be applied to the cloud computing system that uses a server on the Internet as-is.

### SUMMARY OF THE INVENTION

The present invention provides an image input system that is capable of applying to the cloud computing system and of reducing user's load in selecting an image input apparatus used from among a plurality of image input apparatuses on the network.

Accordingly, a first aspect of the present invention provides an image input system comprising a server, an information processing apparatus configured to communicate with the server via the Internet and a wireless communication network, a first image input apparatus configured to be directly connected to the information processing apparatus, and second image input apparatuses configured to be connected to the information processing apparatus via a local network. The server comprises a search message transmission unit configured to transmit a search message for searching an image input apparatus to the information processing apparatus. The information processing apparatus comprises a determination unit configured to determine whether the first image input apparatus is usable in response to reception of the search message from the server, and a selection unit configured to select the first image input apparatus without searching for the second image input apparatuses and to notify the server of the selection when the determination unit determines that the first image input apparatus is usable.

Accordingly, a second aspect of the present invention provides An information processing apparatus that communicates with a server via the Internet and a wireless communication network, is directly connected to a first image input apparatus, and is connected to second image input apparatuses through a local network, comprising a search message reception unit configured to receive a search message for searching an image input apparatus from the server, a determination unit configured to determine whether the first image input apparatus is usable in response to reception of the search message, and a selection unit configured to select the first image input apparatus without searching for the second image input apparatuses and to notify the server of the selection when the determination unit determines that the first image input apparatus is usable.

Accordingly, a third aspect of the present invention provides a control method for an information processing apparatus that communicates with a server via the Internet and a wireless communication network, is directly connected to a first image input apparatus, and is connected to second image input apparatuses through a local network, the control method comprising a search message reception step of receiving a search message for searching an image input apparatus from the server, a determination step of determining whether the first image input apparatus is usable in response to reception of the search message, and a selection step of selecting the first image input apparatus without searching for the second image input apparatuses and to notify the server of the selection when it is determined that the first image input apparatus is usable in the determination step.

Accordingly, a fourth aspect of the present invention provides a non-transitory computer-readable storage medium storing a control program causing a computer to execute the control method of the third aspect.

According to the present invention, the image input system that is capable of applying to the cloud computing system and of reducing the user's load in selecting an image input apparatus used from among a plurality of image input apparatuses on the network can be provided.

Further features of the present invention will become apparent from the following description of exemplary embodiments with reference to the attached drawings.

### BRIEF DESCRIPTION OF THE DRAWINGS

FIG. 1 is a block diagram schematically showing a configuration of an image input system according to an embodiment of the present invention.

FIG. 2 is a block diagram schematically showing configurations of an information processing apparatus and an image input apparatus with which the image input system shown in FIG. 1 is provided.

FIG. 3 is a block diagram schematically showing a configuration of a server with which the image input system shown in FIG. 1 is provided.

FIG. 4 is a view showing a first sequence of a scan process in the image input system in FIG. 1.

FIG. 5 is a view showing a second sequence of the scan process in the image input system in FIG. 1.

FIG. 6 is a view showing a third sequence of the scan process in the image input system in FIG. 1.

FIG. 7 is a flowchart showing a process for fixing an image input apparatus that the information processing apparatus uses in the second sequence in FIG. 5.

FIG. 8 is a flowchart showing a process executed by an information processing apparatus with which a multifunctional peripheral device is provided after fixing the image input apparatus in the second sequence in FIG. 5.

FIG. 9 is a flowchart showing a process in which the server searches for an image input apparatus in the second sequence in FIG. 5.

FIG. 10 is a flowchart showing a process n which the information processing apparatus fixes the image input apparatus used in the third sequence in FIG. 6.

FIG. 11 shows an example of a search screen (a user interface) used for searching for an image input apparatus that is displayed on a display unit of the information processing apparatus.

FIG. 12 shows an example of a list screen (a user interface) used for selecting an image input apparatus used that is displayed on the display unit of the information processing apparatus.

FIG. 13 shows an example of a screen (a user interface) used for fixing an image input apparatus that is displayed on the display unit of the information processing apparatus.

### DESCRIPTION OF THE EMBODIMENTS

Hereafter, embodiments according to the present invention will be described in detail with reference to the drawings.

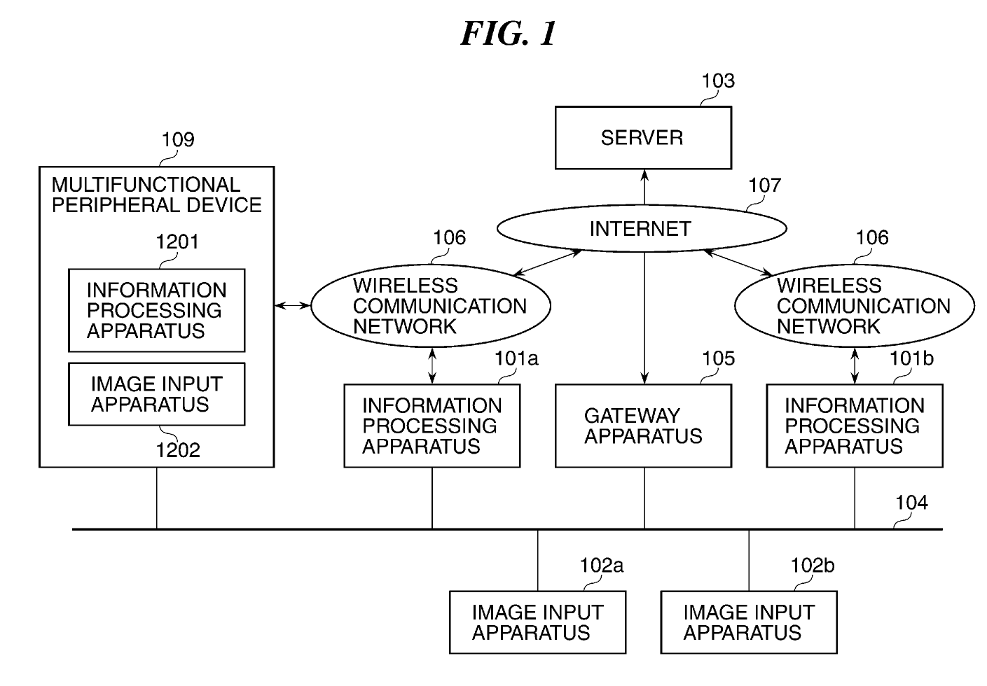

FIG. 1 is a block diagram schematically showing a configuration of an image input system according to an embodiment of the present invention. The image input system is provided with a multifunctional peripheral device 109 that has an information processing apparatus 1201 on which a user operates applications, and a first image input apparatus 1202 that transmits image information (image data) generated by a scan process to external devices. The image input system is provided with information processing apparatuses 101a and 101b on which a user operates applications, and image input apparatuses 102a and 102b as second image input apparatuses that transmit image information (image data) generated by the scan process to external devices.

It should be noted that each of the information processing apparatuses 101a and 101bis represented by an “information processing apparatus 101” when they are not distinguished, and each of the image input apparatuses 102a and 102b is represented by an “image input apparatus 102” when they are not distinguished.

The information processing apparatus 101, the image input apparatuses 102, and the multifunctional peripheral device 109 are connected via a local network 104 that is configured by the Ethernet (registered trademark). The numbers of the information processing apparatus 101 and the image input apparatuses 102 are not limited to the illustrated example. A gateway apparatus 105 is connected to the local network 104, and is also connected to the Internet 107. The information processing apparatus 101a (101b, 1201) and the server 103 are connected via a wireless communication network 106 like a cellular phone network communication and the Internet 107.

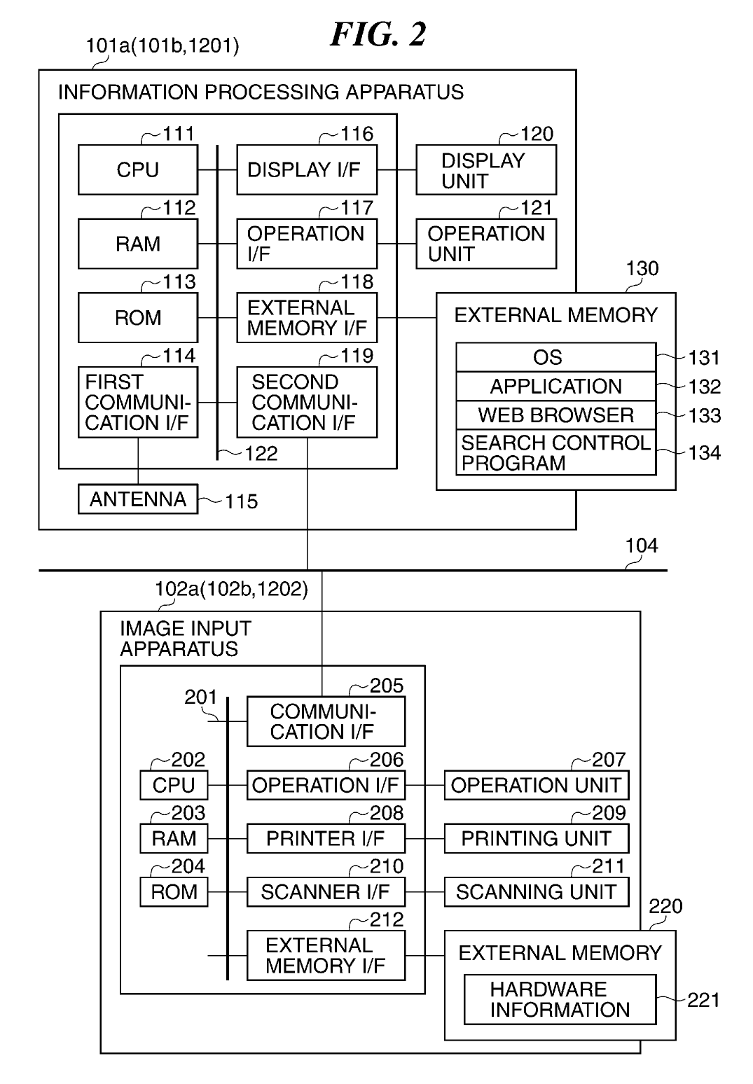

FIG. 2 is a block diagram schematically showing configurations of the image forming apparatus 101a (101b, 1201) and the image input apparatus 102a (102b, 1202).

In the information processing apparatus 101a (101b, 1201), a CPU 111 develops a program stored in a ROM 113 to the work area of a RAM 112 and executes it. The CPU 111 totally controls devices connected to a system bus 122. In addition to the program, the ROM 113 stores data required for various controls. The RAM 112 functions as a main memory, and functions as the work area for the CPU 111.

An operation I/F 117 controls inputs from an operation unit 121 and a pointing device like a touch panel (not shown). A display I/F 116 controls indications of various pieces of information to a display unit 120. The display unit 120 is provided with a touch-panel function, and bears a part of the functions of the operation unit 121.

An external memory 130 comprises a flash memory or a solid state disk (SSD), for example, and an external memory I/F 118 controls an access to the external memory 130. The external memory 130 stores an operating system program (an OS) 131, various applications 132, a web browser 133, and a search control program 134. The external memory 130 functions also as a storage medium for various kinds of data that the information processing apparatus 101a (101b-1201) can store or read.

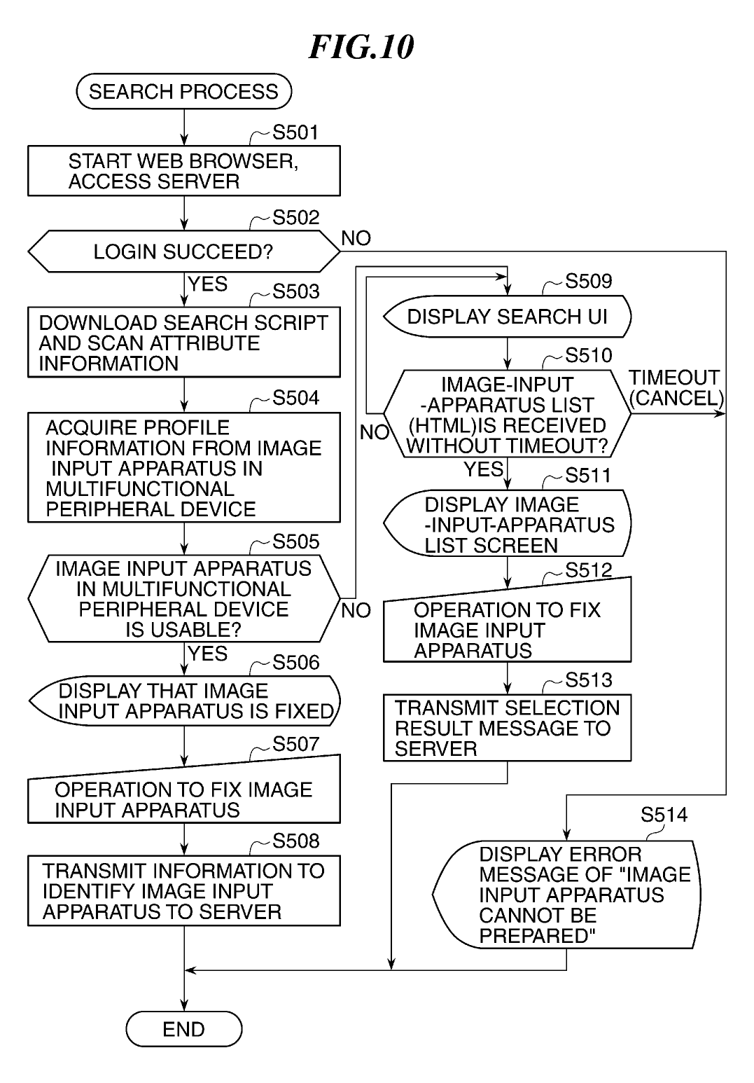

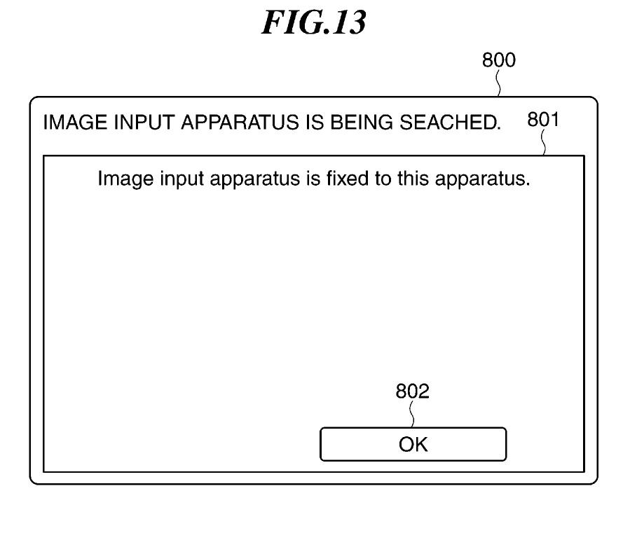

It should be noted that various scripts running on the web browser 133 of the information processing apparatus 101a (101b, 1201) have not been saved in the external memory 130 of the information processing apparatus 101a (101b-1201) used by a user in an initial state. In this embodiment, when a script that manages construction of an operating environment for the image input system is not saved in the information processing apparatus 101a (101b-1201), the web browser 133 executed on the OS 131 in the information processing apparatus 101a (101b-1201) downloads (acquires) the script from the server 103. The CPU 111 starts the downloaded script on the RAM 112 so as to run on the web browser 133. A search process by the search control program 134, which is a characteristic composition of the present invention, will be described later in detail with reference to FIG. 10 and FIG. 13.

A first communication I/F 114 is a control unit for communicating using the wireless communication network 106, and network connection with a base transceiver station through an antenna 115. A second communication I/F 119 is a control unit for a wireless network (Wi-Fi etc.) or a preference network, and enables connection with the local network 104 through a Wi-Fi antenna or a network terminal (not shown).

In the image input apparatus 102a (102b, 1202), the CPU 202 controls the entire operation of the apparatus by totally controlling devices connected to a system bus 201. A RAM 203 functions as a main memory of the CPU 202, a work area, etc., and is used as an inputting information development area, an environment data storage area, etc. The RAM 203 is provided with a NVRAM (Non-volatile RAM) area, and can extend a memory space using an option RAM connected to an add-on port (not shown).

A ROM 204 stores various fonts, a control program executed by the CPU 202, and various kinds of data. A communication I/F 205 is connected to the local network 104 and enables transmission and reception of data with the information processing apparatus 101a (101b, 1201). A printer I/F 208 controls communications with a printing unit 209 that is a printer engine. A scanner I/F 210 controls communications with a scanning unit 211 that is a scanner engine.

An external memory 220 comprises a flash memory or a solid state disk (an SSD), for example, and the external memory I/F 212 controls an access to the external memory 220. In this embodiment, the external memory 220 is able to store hardware information 221. The hardware information 221 includes, for example, the name of the image input apparatus 102a (102b, 1202), input ability information like resolutions and sheet sizes supported, and transmission capacity information (for example, SMB or WebDAV) to an external apparatus like the server 103. It should be noted that the ROM 204 stores the information used by the information processing apparatus 101, when the external memory 220 is not connected to the image input apparatus 102a (102b, 1202).

An operation unit 207 that sets up the scan process by the image input apparatus 102a (102b, 1202) is provided with an operation panel that accepts operations by a user. Switches for operations, LED indicators, etc. are arranged on the operation panel. It should be noted that an NVRAM (not shown) may be provided in order to store the scan setting information from the operation panel. An operation I/F 206 controls communications with the operation unit 207.

The CPU 202 acquires image data from the scanning unit 211 via the scanner I/F 210 based on the control program etc. stored in the ROM 204. The CPU 202 can communicate with the Information processing apparatus 101a (101b, 1201) via the communication I/F 205. The CPU 202 transmits image data to the information processing apparatus 101a (101b, 1201), and notifies the information processing apparatus 101a (101b, 1201) of the information within the image input apparatus 102a (102b, 1202). In this embodiment, the communication I/F 205 mounts a corresponding web service protocol or an original search protocol and a scan protocol.

It should be noted that the information processing apparatus 101a (101b, 1201) and the image input apparatus 102a (102b, 1202) are connected via the local network 104, the second communication I/F 119 and the communication I/F 205 in FIG. 2. Aside from this, the information processing apparatus 1201 and the image input apparatus 1202 are directly connected via the system buses 122 and 201 in the multifunctional peripheral device 109.

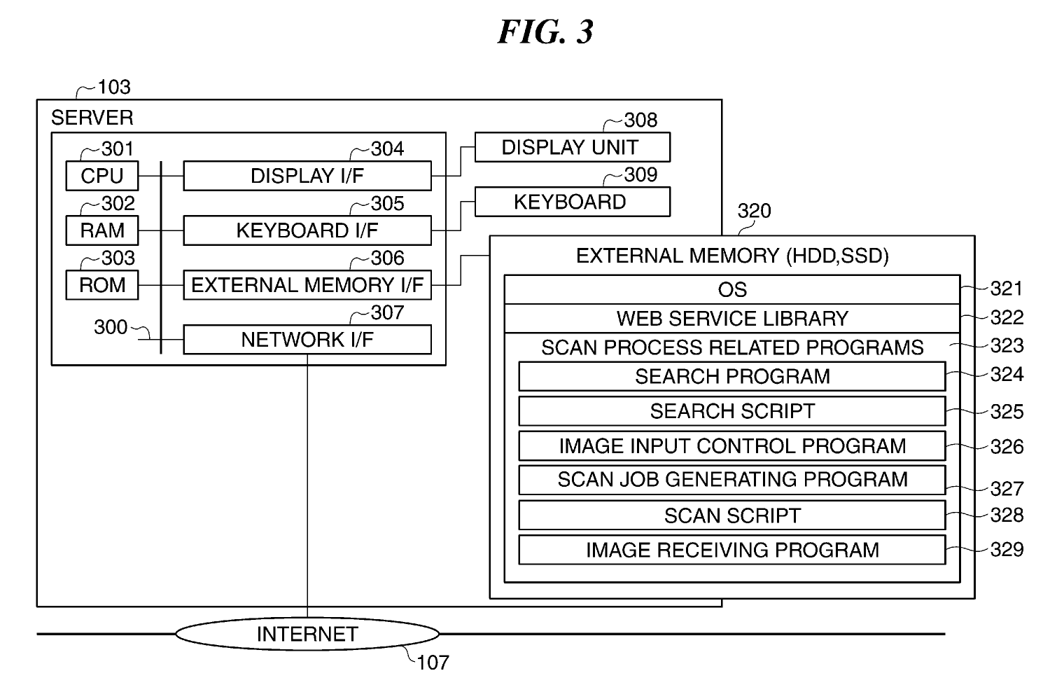

FIG. 3 is a block diagram schematically showing a configuration of the server 103. In the server 103, a CPU 301 totally controls various devices connected to a system bus 300 by developing a program stored in a ROM 303 to a work area of a RAM 302 and executing it. In addition to the program, the ROM 303 stores data required for various controls. The RAM 302 functions as a main memory, and functions as the work area for the CPU 301.

A keyboard controller I/F 305 controls inputs from a keyboard 309 and a pointing device (not shown) like a mouse. A display I/F 304 controls indications of various pieces of information to a display unit 308. An external memory 320 comprises a hard disk drive (an HDD), a solid state disk (SSD), etc., for example. An external memory I/F 306 controls access to the external memory 320.

The external memory 320 stores an operating system program (an OS) 321, a web service library 322, and scan processing related programs 323. The external memory 320 functions as a computer-readable/recordable storage medium that stores user files and edit files (not shown), etc.

The scan processing related programs 323 include a search program 324, a search script 325, an image input control program 326, a scan job generating program 327, a scan script 328, and an image receiving program 329. Functions of these programs will be described later together with the descriptions of a sequence and a flowchart of the scan process.

A network I/F 307 is connected to the information processing apparatus 101a (101b, 1201) via the Internet 107 and the wireless communication network 106 (FIG. 1). Accordingly, the server 103 indirectly communicates with the image input apparatus 102a (102b, 1202) via the local network 104.

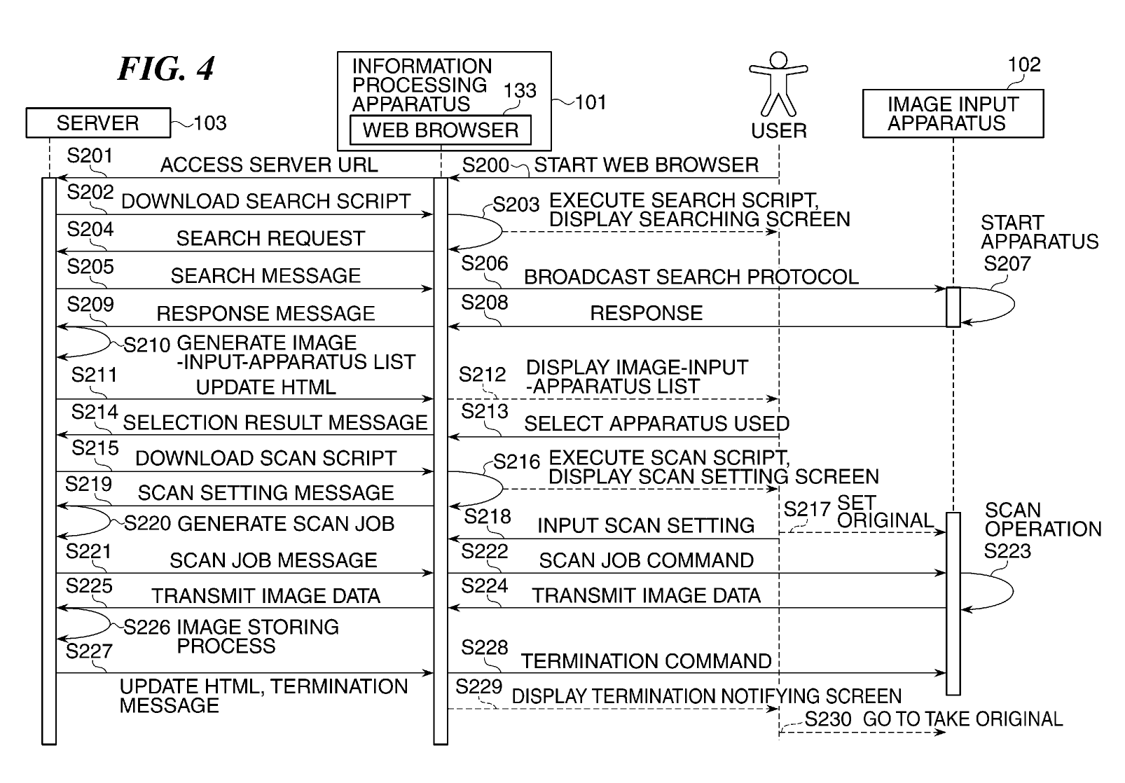

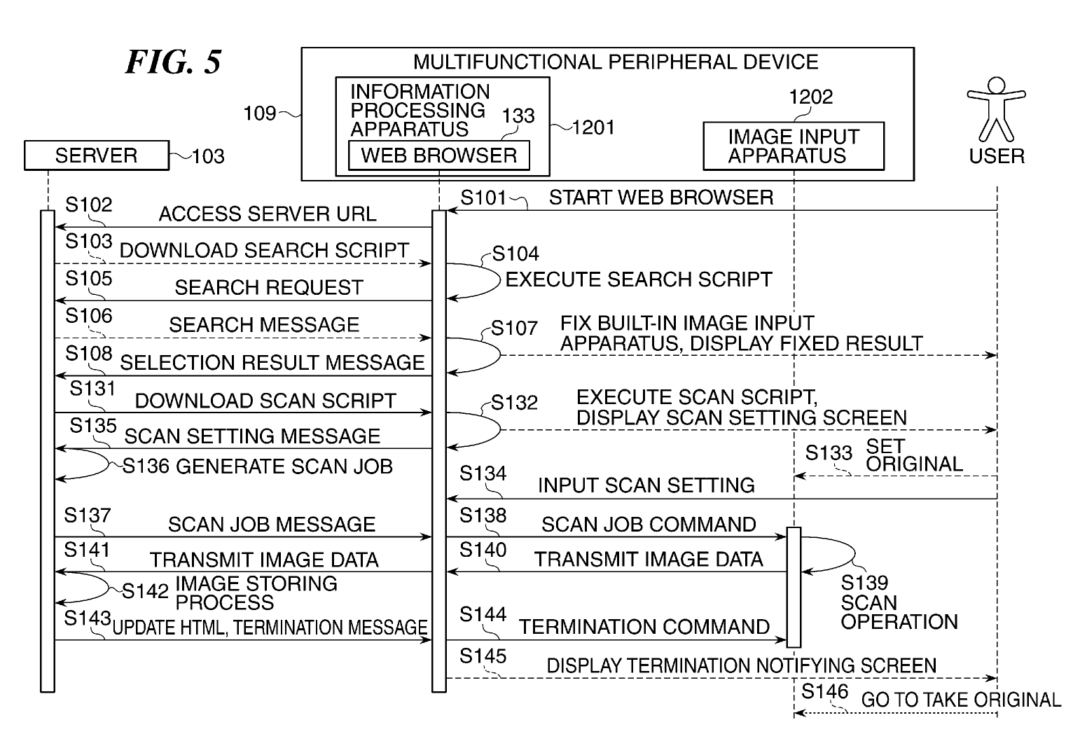

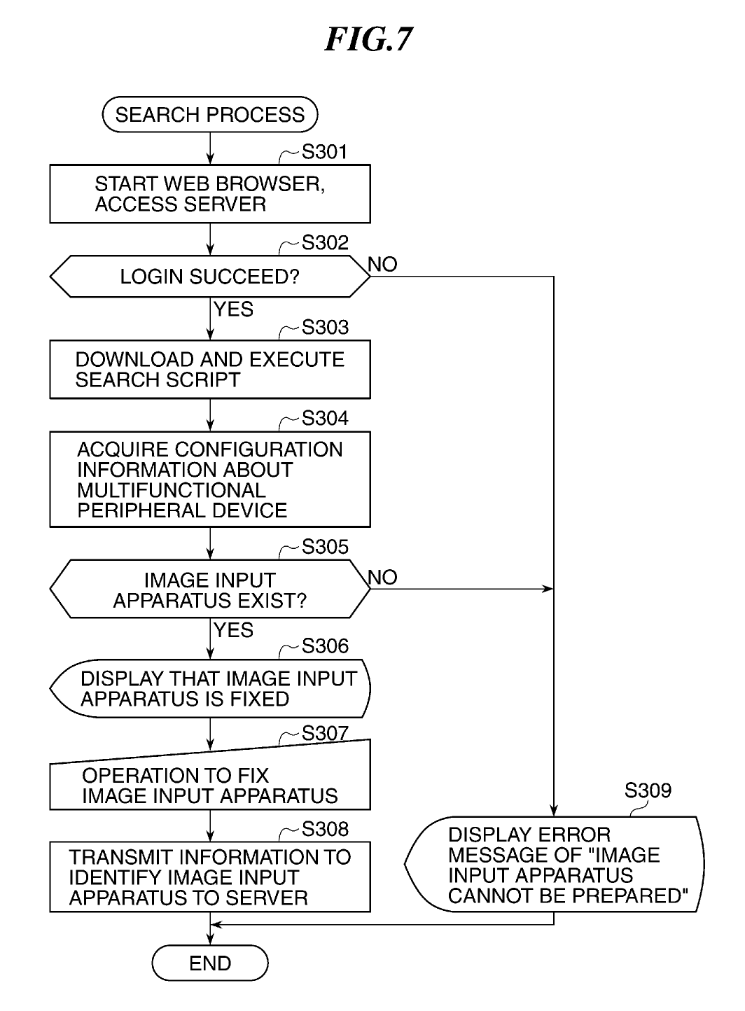

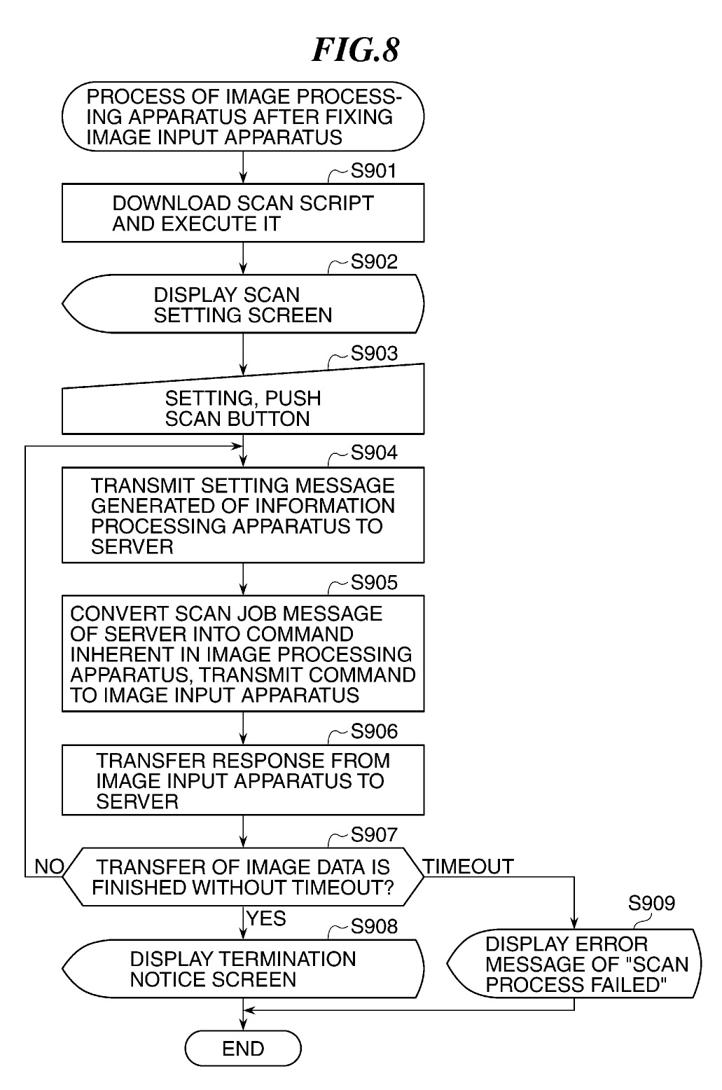

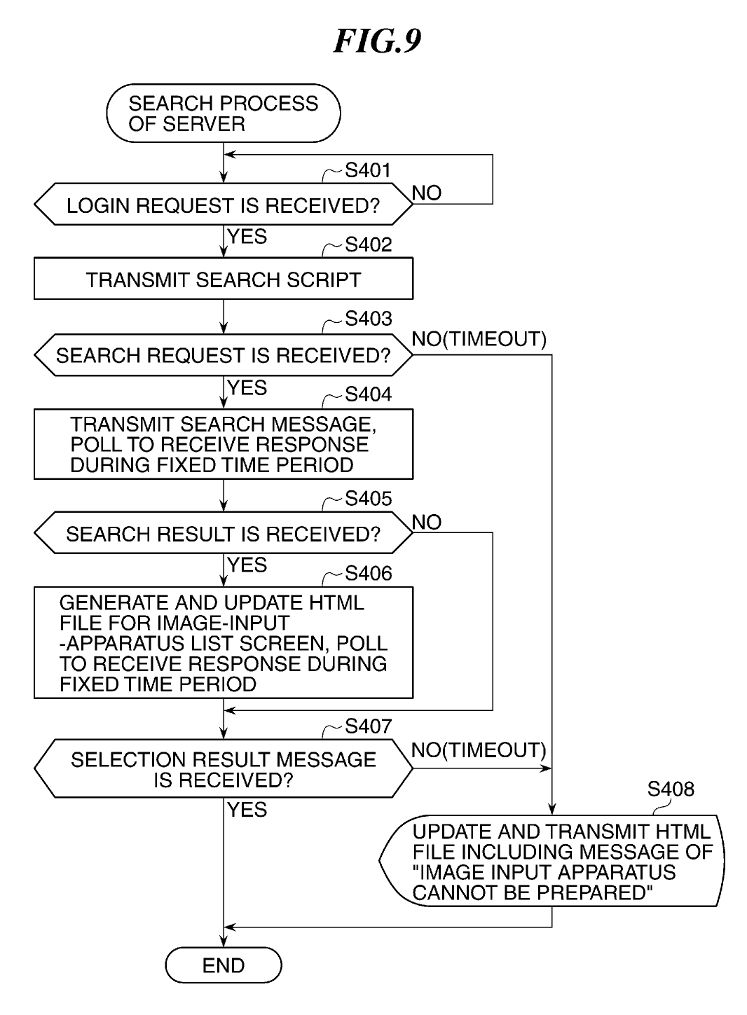

Sequences of the scan process in the image input system of the embodiment will be described. Namely, an environment under which the respective apparatuses that constitute the image input system execute a series of procedures of the scan process will be described. Here, a first sequence of the scan process in a configuration where the multifunctional peripheral device 109 is removed from the image input system in FIG. 1 will be described first with reference to FIG. 4. Subsequently, a second sequence of the scan process in a configuration where the information processing apparatus 101 and the image input apparatus 102 are removed from the image input system in FIG. 1 will be described with reference to FIG. 5, FIG. 7, FIG. 8 and FIG. 9.

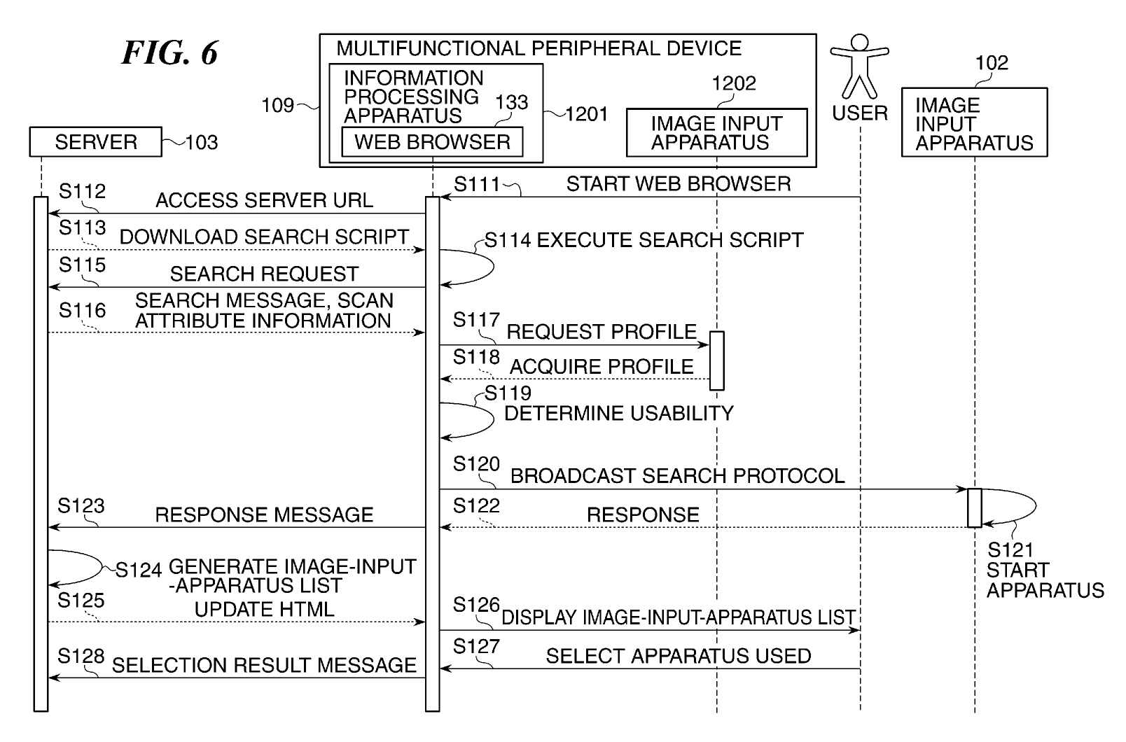

Then, a third sequence of the scan process in the image input system in FIG. 1, which is provided with the information processing apparatus 101, the image input apparatus 102, and the multifunctional peripheral device 109, will be described with reference to FIG. 6 and FIG. 10. However, since the information processing apparatus 1201 in the multifunctional peripheral device 109 is used as an information processing apparatus in the third sequence, the information processing apparatus 101 is not illustrated in FIG. 6. It should be noted that the descriptions for the second and third sequences are focused on a search sequence that is a characteristic composition of the present invention in the descriptions for the second sequence and the third sequence.

FIG. 4 is a view showing the first sequence of the scan process. Here, the information processing apparatus 101 is assumed to be already accessible to the image input apparatus 102 via the local network 104. The web browser 133 on the information processing apparatus 101 is assumed to be running on the RAM 112 so as to be accessible to the server 103.

First, a user operates the operation unit 121 of the information processing apparatus 101 to start the web browser 133 (step S200). Next, the web browser 133 of the information processing apparatus 101 accesses the URL of the server 103, and logs in to the URL (step 5201) in order to use an image input service (a scan process service) that the server 103 provides. When the login succeeds, the search script 325 is downloaded from the server 103 to the web browser 133 (step S202).

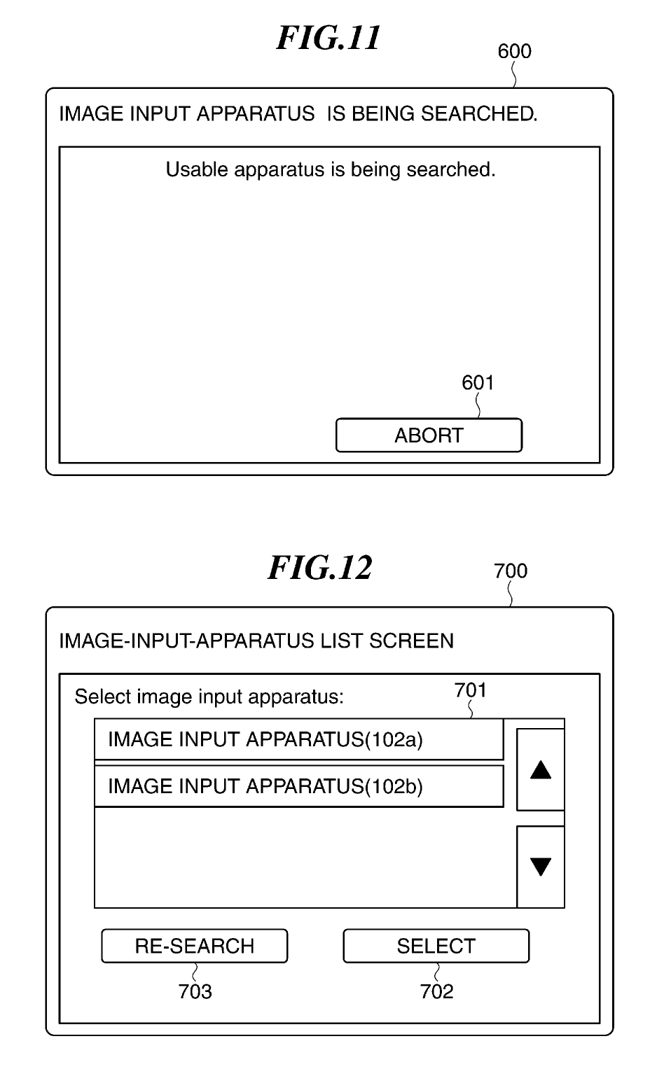

Subsequently, the search script 325 downloaded to the web browser 133 of the information processing apparatus 101 is executed on the web browser 133, and operates. Hereafter, “the search script 325 running on the web browser 133 of the information processing apparatus 101” is referred to as “the search script 325 on the information processing apparatus 101”. The search script 325 on the information processing apparatus 101 displays a search screen as shown in FIG. 11 as an example for a user (step S203), and issues a search request for an image input apparatus to the server 103 (step S204).

It should be noted that the search script 325 transmits an update message for an HTML file to the server 103 periodically, while the search script 325 is executed on the web browser 133. The process is not illustrated. Then, the server 103 updates the HTML file and transmits it to the information processing apparatus 101. Accordingly, the search screen (FIG. 11) is updated and the user can check the change of state of the server 103. The details of the search screen in FIG. 11 will be described later.

When receiving the search request, the server 103 transmits a search protocol (step S205). Specifically, in the step 5205, the search program 324 on the server 103 transmits a search message including the search protocol that searches for the image input apparatus 102a (102b, 1202) to the information processing apparatus 101.

The information processing apparatus 101 receives the search message by the search script 325. The information processing apparatus 101 transmits the search message received by the search script 325 to the local network 104 by broadcasting using a transfer method like an IP header conversion process for packet data (step S206).

It should be noted that the conversion process for the packet data in the step 5206 has a function with which the information processing apparatus 101 is provided to notify the image input apparatus 102 of information correctly from the server 103. A detailed description about the function is omitted.

The image input apparatus 102 starts in step S207 by receiving the search protocol of the broadcasting transmitted in the step S206. The image input apparatus 102 on the local network 104 determines whether the apparatus itself corresponds to the search protocol. When it corresponds, the apparatus 102 transmits a response to the information processing apparatus 101 of the broadcast transmission source (step S208).

When receiving the response in the step S208, the search script 325 on the information processing apparatus 101 converts the response into a response message, and transmits it to the server 103 one by one (step S209). The process for converting the response into the response message in the step S209 is a function with which the information processing apparatus 101 is provided to notify the server 103 of information about the image input apparatus 102 correctly. A detailed description about the function is omitted.

The server 103 analyzes the response message received from the information processing apparatus 101 by means of the image input control program 326, and generates a list of the image input apparatuses 102a and 102b obtained by the search (step S210). The image-input-apparatus list generated in the step S210 is converted into an HTML file by the image input control program 326, is updated, and is transmitted to the information processing apparatus 101 from the server 103 (step S221). The search script 325 on the information processing apparatus 101 displays an image-input-apparatus list screen as shown in FIG. 12 as a user interface on the display unit 120 based on the HTML file received by the list transmitting process in the step S211 (step S212). It should be noted that the details of the image-input-apparatus list screen in FIG. 12 will be described later.

The user selects the image input apparatus used from among the image input apparatuses 102 displayed on the image-input-apparatus list (step S213). Then, the search script 325 on the information processing apparatus 101 transmits the selection result to the server 103 (step S214). It should be noted that the process by the search script 325 on the information processing apparatus 101 is finished in the step S214.

The server 103 selects the scan script 328 suitable for the selected image input apparatus by the image input control program 326, and transmits the selected script to the information processing apparatus 101 (step S215). The scan script 328 downloaded is executed on the web browser 133 of the information processing apparatus 101, and operates. Hereafter, “the scan script 328 running on the web browser 133 of the information processing apparatus 101” is referred to as “the scan script 328 on the information processing apparatus 101”.

The scan script 328 on the information processing apparatus 101 displays a scan setting screen on the display unit 120 as a user interface (step S216). It should be noted that the user can designate generation conditions for image data by scanning (for example, a color mode of scanning, resolution of scanning, an image size of scanning, etc.) and a preservation destination of generated image data through the scan setting screen (not shown).

The user who looks at the scan setting screen sets an original to the selected image input apparatus (step S217), and inputs the scan conditions through the scan setting screen (step S218). It should be noted that the scan script 328 transmits an update message for an HTML file to the server 103 periodically, while the scan script 328 is executed on the web browser 133. The process is not illustrated. The server 103 updates the HTML file and transmits it to the information processing apparatus 101. Accordingly, the scan setting screen FIG. 11 is updated and the user can check the change of state of the server 103.

The scan script 328 on the information processing apparatus 101 transmits the set contents to the server 103 as a setting message (step S219). In the server 103, the scan job generating program 327 generates a scan job according to the received setting message (step S220). Then, the server 103 transmits the generated scan job to the information processing apparatus 101 as a scan job message (step S221).

The scan script 328 on the information processing apparatus 101 transmits the received scan job message to the image input apparatus selected as a job command (step S222). When receiving the job command, the selected image input apparatus executes a scan operation to generate image information (image data), and transmits the image data generated to the information processing apparatus 101 (step S224). Then, the information processing apparatus 101 transmits the received image data to the server 103 (step S225).

Although the types of image data depend upon transmission systems by the image input apparatus 102, the scan script 328 on the information processing apparatus 101 performs a process similar to the operation of the search script 325 in the step S209. That is, in the step S225, the scan script 328 on the information processing apparatus 101 transmits the image data to the server 103 while keeping its content using a transfer method like an IP header conversion process for packet data.

In the server 103, since the image input apparatus 102 used has been already selected, the image receiving program 329 applies a suitable image conversion process according to the type of the received image data, and applies an image storage process after the image conversion process (step S226). Then, the server 103 updates the HTML file, and transmits a termination message to the information processing apparatus 101 (step S227).

The scan script 328 on the information processing apparatus 101 converts the received termination massage into a termination command, and transmits the command to the image input apparatus selected (step S228). The scan script 328 on the information processing apparatus 101 displays a termination notice screen (not shown) for the scan process on the display unit 120 as a user interface, and thereby, notifies a user of the termination of the job (step S229). It should be noted that the process by the scan script 328 on the information processing apparatus 101 is finished in the step S229.

Then, the sequence of the scan process in this embodiment is finished when the user goes to take the original that has been scanned to the image input apparatus (step S230). The image data that is generated by scanning the original is stored into the server 103 according to the above-mentioned sequence.

FIG. 5 is a view showing a second sequence of the scan process. Here, the web browser 133 on the information processing apparatus 1201 is assumed to be running on the RAM 112 so as to be accessible to the server 103.

A user operates the operation unit 121 of the information processing apparatus 1201 to start the web browser 133 (step S101). The web browser 133 on the information processing apparatus 1201 accesses the URL of the server 103, and logs in to the URL (step S102) in order to use an image input service that the server 103 provides. When the login successes, the search script 325 is downloaded from the server 103 to the information processing apparatus 1201 (step S103), and it is executed on the web browser 133 (step S104). Thereby, the search screen as shown in FIG. 11 is displayed on the display unit 120. The search script 325 on the information processing apparatus 1201 transmits a search request to the server 103 (step S105).

The server 103 transmits a search message to the information processing apparatus 1201 by the search program 324 (step S106). When the search script 325 on the information processing apparatus 1201 has recognized that the image input apparatus 1202 exists inside the multifunctional peripheral device 109, it fixes the image input apparatus 1202 (the built-in image input apparatus) of the multifunctional peripheral device 109 as the image input apparatus used. The search script 325 on the information processing apparatus 1201 simultaneously displays a message showing to fix the image input apparatus 1202 as the image input apparatus used for the user (step S107). The search script 325 on the information processing apparatus 1201 notifies the server 103 of the selection result message showing that the image input apparatus 1202 is used (step S108), and thereby, finishes the search process for an image input apparatus. It should be noted that the process by the search script 325 on the information processing apparatus 1201 is finished in the step S108.

The search script 325 transmits an update message for an HTML file to the server 103 periodically, while the search script 325 is executed on the web browser 133. The server 103 updates the HTML file and transmits it to the web browser 133. Accordingly, the search screen (see FIG. 11) is updated and the user can check the change of state of the server 103.

Since the process from step S131 to step S146 in FIG. 5 is equivalent to the process from the step S215 to the step S230 in FIG. 4, detailed description is omitted.

It should be noted that the information processing apparatus 1201 and the image input apparatus 1202 are directly connected via the system bus 122 and the system bus 201. Therefore, information (data) that is exchanged between the information processing apparatus 1201 and the image input apparatus 1202 in the step S138, S140, or S144 is converted into an inherent command before exchanging. This conversion process is executed by the search control program 134.

FIG. 7 is a flowchart showing a process that fixes the image input apparatus used in the second sequence without searching for the image input apparatuses 102 on the local network 104 by the information processing apparatus 1201.

In this process, the CPU 111 of the information processing apparatus 1201 starts the web browser 133 on the OS 131, and accesses the server 103 from the web browser 133 (step S301). Then, the CPU 111 determines whether the login succeeded based on a response from the server 103 (step S302).

When the login failed (NO in the step S302), the CPU 111 proceeds with the process to step S309. In the step S309, the CPU 111 receives an HTML file including an error message showing that a scan process environment cannot be generated (for example, “IMAGE INPUT APPARATUS CANNOT BE PREPARED”) from the server, displays the message, and finishes the search process.

On the other hand, when the login succeeded (YES in the step S302), the CPU 111 downloads the search script 325 and an HTML file from the server 103, and executes them on the web browser 133 (step S303). Then, the CPU 111 transmits a search request to the server 103 by the search script 325. When receiving a search message as a response, the CPU 111 acquires configuration information about the devices with which the multifunctional peripheral device 109 is provided (step S304).

Subsequently, the CPU 111 determines whether the acquired configuration information includes information about an image input apparatus (step S305). When the information is not included (NO in the step S305), the CPU 111 proceeds with the process to the step S309. It should be noted that the contents of process in the step S309 has been already described, and therefore the description here is omitted. When the information about an image input apparatus is included (YES in the step S305), the CPU 111 fixes the image input apparatus (the image input apparatus 1202) used by means of the search control program 134 (step S306).

Next, the CPU 111 acquires an HTML file including a message showing that the image input apparatus is fixed from the server 103 by the search script 325, and displays a user interface shown in FIG. 13 onto the display unit 120 (step S306). This urges the user to perform a fixing operation for the image input apparatus. It should be noted that details of FIG. 8 will be described later. Subsequently, when the user performs the final fixing operation (step S307), the CPU 111 transmits the information to identify the image input apparatus 1202 to the server 103 by the search script 325 (step S308), and finishes the search process.

It should be noted that the process of the information processing apparatus 1201 to transmit the HTML file held to the web browser, and to transmit the information to identify the image input apparatus to the server 103 according to the fixing operation by the user is inherent in the information processing apparatus 1201 with which the multifunctional peripheral device 109 is equipped. However, the embodiment is not restricted to this. For example, the process in the steps S209 through 5214 in FIG. 4, which assumes that the HTML file is acquired from the server 103, may be employed.

FIG. 8 is a flowchart showing a process executed by the information processing apparatus 1201 with which the multifunctional peripheral device 109 is provided after fixing the image input apparatus in the second sequence. The scan script 328 corresponding to the image input apparatus 1202 is transmitted to the web browser 133 on the information processing apparatus 1201 from the server 103. Thereby, the CPU 111 executes the scan script 328 received on the web browser 133 (step S901). The CPU 111 displays a scan setting screen (not shown) on the display unit 120 of the information processing apparatus 1201 by the scan script 328 (step S902), and urges the user to perform the scan setting and to start the scan process (step S903).

When the user pushes a scan button (not shown) included in the scan setting screen, the CPU 111 transmits the scan setting message generated by the information processing apparatus 1201 to the server 103 by the scan script 328 (step S904). Then, since a scan job message is transmitted from the server 103, the CPU 111 converts the scan job message into an inherent command by the search control program 134, and transmits the command to the image input apparatus 1202 (step S905).

When the image input apparatus 1202 scans the original according to the scan job command and generates image data, the image input apparatus 1202 transmits a response including the image data to the information processing apparatus 1201. The CPU 111 repeats the transfer of the received response to the server 103 (step S906). Thereby, the image data included in the response is transmitted to the server 103.

The CPU 111 determines whether timeout, which means that the image data is not received from the image input apparatus 1202 during a predetermined time period, occurs, and determines whether the transfer of the image data is finished (step S907). It is determined whether the transfer of the image data is finished (whether the scan of the original by the image input apparatus is finished) based on the termination message (see S227) that is transmitted from the server 103.

When the timeout does not occur and the termination message is not received (NO in the step S907), the CPU 111 return the process to the step S904. When the timeout occurs (TIMEOUT in the step S302), the CPU 111 proceeds with the process to the step S909. In the step S909, the CPU 111 receives an HTML file including an error message of “SCAN PROCESS FAILED” (see S227) from the server 103 by the web browser 133, displays it on the display unit 120, and then, finishes the process. It should be noted that the same process as in the case of timeout is performed when the scan process is canceled.

When the preservation of the image data is normally completed (YES in the step S907), the CPU 111 displays the termination notice screen (see S229) by the web browser 133, and notifies the user that the image data is stored into the server 103 (step S908). Thereby, the information processing apparatus 1201 finishes the process performed after fixing the image input apparatus.

FIG. 9 is a flowchart showing a process in which the server 103 searches for the image input apparatus 1202 in the second sequence. The server 103 determines whether the login request is received from the information processing apparatus 1201 (step S401), and waits until receiving the login request (NO in the step S401). When receiving the login request (YES in the step S400), the CPU 301 transmits the search script 325 to the information processing apparatus 1201 by the search program 324 (step S402).

Since a search request is transmitted to the server 103 when the search script 325 is executed on the web browser 133 of the information processing apparatus 1201, the CPU 301 determines whether this search request is received (step S403). When the search result has not been received within the fixed time period (NO in the step S403), the CPU 301 proceeds with the process to step S408. In the step S408, the CPU 301 generates an HTML file including an error message showing that a scan process environment cannot be generated (for example, “IMAGE INPUT APPARATUS CANNOT BE PREPARED”), and transmits the file to the web browser 133 of the information processing apparatus 1201. The CPU 301 terminates the process after the process in the step S408.

It should be noted that the CPU 301 generates the HTML file including the above-mentioned message in the step S409 as a response to the update message for the HTML file that is transmitted by the search script 325 on the information processing apparatus 1201 to the server 103 periodically.

When receiving the search request (YES in the step S403), the CPU 301 transmits a search message to the information processing apparatus 1201 by the search program 324. The CPU 301 waits for receiving the search result message from the information processing apparatus 1201 during a fixed time period at constant intervals (poll to receive; step S404), and determines whether the search result message is received within the fixed time period (step S405).

When receiving the search result message within the fixed time period (YES in the step S405), the CPU 301 generates an HTML file including the image-input-apparatus list screen, transmits it to the information processing apparatus 1201, and waits for receiving during the fixed time period at the constant intervals (step S406). After finishing the process in the step S406, or when the search result message is not received within the fixed time period (i.e., when the received message is not a search result; NO in the step S405), the CPU 301 proceeds with the process to step S407.

In the step S407, the CPU 301 determines whether the selection result message for the image input apparatus is received within the fixed time period. When the selection result message has not been received within the fixed time period and a timeout occurs (NO in the step S404), the CPU 301 proceeds with the process to the step S408. Since the process in the step S408 has been already described, a description here is omitted. When the selection result message is received within the fixed time period (YES in the step S407), the image input apparatus used is fixed. Therefore, the CPU 301 finishes the search process by the search program 324.

Each of the determination not to be the search result message in the step S405 and the determination to be the selection result message for the image input apparatus in the step S407 corresponds to a characteristic process of this embodiment that the information processing apparatus 1201 of the multifunctional peripheral device 109 immediately fixes to use the image input apparatus 1202.

FIG. 6 shows a third sequential chart of the scan process. Here, the information processing apparatus 1201 is assumed to be accessible to the image input apparatus 102a (102b, 1202) via the local network 104. The web browser 133 on the information processing apparatus 1201 is assumed to be running on the RAM 112 so as to be accessible to the server 103.

First, a user operates the operation unit 121 of the information processing apparatus 1201 to start the web browser 133 (step S111). The web browser 133 accesses the URL of the server 103, and logs in to the URL (step S112) in order to use an image input service that the server 103 provides. When the login successes, the search script 325 is downloaded from the server 103 to the information processing apparatus 1201 (step S113), and it is executed on the web browser 133 (step S114). Accordingly, since the search screen including the message of “IMAGE INPUT APPARATUS IS BEING SEARCHED” as shown in FIG. 11 is displayed on the display unit 120, the user is notified of the progress state of the process. Then, the search request for an image input apparatus is transmitted to the server 103 (step S115).

While the search script 325 is executed, the update message for the HTML file is periodically transmitted to the server 103 from the information processing apparatus 1201, and the server 103 updates the HTML file and transmits it to the web browser 133. Accordingly, the search screen (see FIG. 11) is updated and the user can check the change of state of the server 103.

When receiving the search request, the server 103 transmits a search message and scan attribute information to the information processing apparatus 1201 by the search program 324 (step S116). It should be noted that the scan attribution information is information with which the image input apparatus 1202 has to be provided in consideration of a business logic in the server 103, and specifically, the attribution information includes necessary image data characteristics, such as a color mode (monochrome or color) and resolution. The search script 325 on the information processing apparatus 1201 receives the search message and the scan attribution information.

The search script 325 on the information processing apparatus 1201 recognizes that the image input apparatus 1202 exists inside the multifunctional peripheral device 109, and then, requests the image input apparatus to transmit profile information (step S117). The profile information is information about reading capabilities, such as a color mode (monochrome or color) and resolution.

Subsequently, the search script 325 on the information processing apparatus 1201 acquires the profile information that the image input apparatus 1202 transmits in response to the profile information transmission request in the step S117 (step S118). Then, the search control program 134 on the information processing apparatus 1201 determines whether the image input apparatus 1202 is usable (step S119). In the step S119, the search control program 134 compares the profile information acquired with the scan attribution information received from the server 103, and determines whether the profile information contains the data having the necessary characteristics in consideration of the business logic. When determining that the image input apparatus 1202 is usable in the step S119, the search script 325 on the information processing apparatus 1201 performs a process equivalent to the step S107 and S108 in FIG. 5, and finishes the search process.

The process below the step S119 in FIG. 6 is executed when the profile information does not have the necessary characteristics in consideration of the business logic (it is not usable) in the step S119. The search script 325 on the information processing apparatus 1201 broadcasts the search protocol for searching for an image input apparatus on the local network 104 to the local network 104 (step S120), when the image input apparatus 1202 is not usable.

The image input apparatus 102 on the local network 104 starts by receiving this search protocol (step S121), and returns a response to the web browser 133 (step S122). The search script 325 on the information processing apparatus 1201 transmits the received response to the server 103 as a response message (step S123).

The response message includes the result of search for an image input apparatus. Therefore, the server 103 generates an HTML file for displaying a list, which urges the user to select an image input apparatus, on the information processing apparatus 1201 by the image input control program 326 based on the received response message (step S124).

It should be noted that the scan attribution information may be broadcasted simultaneously with the search protocol in the step S120. In such a case, only the image input apparatus that matches the scan attribution information among the image input apparatuses 102 only returns a response in step S122. Accordingly, only the image input apparatus that returned the response is displayed in the image-input-apparatus list generated in the step S124. On the other hand, only the search protocol may be broadcasted in the step S120 so that all the image input apparatuses 102 return responses in the step S122. In this case, the server 103 analyzes the response message, determines whether an image input apparatus matches the scan attribution information, and displays only the image input apparatus that matches the scan attribution information in the image-input-apparatus list.

The image input control program 326 transmits the HTML file for displaying the image-input-apparatus list to the web browser 133 on the information processing apparatus 1201 (step S125) as a response to an update message for the HTML file that is transmitted by the information processing apparatus 1201 to the server 103 periodically.

The search script 325 on the information processing apparatus 1201 displays the image-input-apparatus list on the display unit 120 based on the received HTML file, and urges the user to select an image input apparatus used (step S126). It should be noted that the search script 325 continues a reception polling until the user selects an image input apparatus. When the user selected the image input apparatus used (step S127), the search script 325 on the information processing apparatus 1201 transmits the selection result to the server 103 as a message (step S128). Thereby, the search process for an image input apparatus is completed.

When the image input apparatus 1202 is fixed to use, the process equivalent to that in the steps S131 through S146 in FIG. 5 is executed after fixing the image input apparatus used until the image input apparatus used generates image data and transmits it to the server 103. On the other hand, when the image input apparatus 102 is fixed to use, the process equivalent to that in the steps S215 through S230 in FIG. 4 is executed so that the image input apparatus 102 generates image data and transmits it to the server 103.

FIG. 10 is a flowchart showing a process in which the information processing apparatus 1201 searches for an image input apparatus in the third sequence. The information processing apparatus 1201 with which the multifunctional peripheral device 109 is provided searches for another image input apparatus (the image input apparatus 102, for example) on the local network 104, only when the image input apparatus 1202 does not satisfy a use condition.

The CPU 111 of the information processing apparatus 1201 starts the web browser 133 on the OS 131, and accesses the server 103 from the web browser 133 (step S501). Then, the CPU 111 determines whether the login succeeded based on a response from the server 103 (step S502). When the login failed (NO in the step S502), the CPU 111 proceeds with the process to step S514. In the step S514, the CPU 111 receives an HTML file including an error message showing that a scan process environment cannot be generated (for example, “IMAGE INPUT APPARATUS CANNOT BE PREPARED”) from the server 103, displays the message, and finishes the search process.

When the login succeeded (YES in the step S501), the CPU 111 downloads the search script 325, the scan attribution information, and the HTML file from the server 103 by the web browser 133 (step S503). The CPU 111 executes the search script 325 on the web browser 133. When determining that the multifunctional peripheral device 109 has the image input apparatus 1202, the CPU 111 acquires profile information from the image input apparatus 1202 (step S504). Then, the CPU 111 compares the scan attribution information received in the step S503 with the profile information acquired in the step S504 by the search control program 134, and determines whether the image input apparatus 1202 is usable (step S505).

When determining that the image input apparatus 1202 is usable, i.e., image data can be generated (YES in the step S505), the CPU 111 fixes to use the image input apparatus 1202 by the search control program 134. Then, the CPU 111 notifies the user that the image input apparatus 1202 is fixed to use by the search script 325, and displays the screen (see FIG. 13) that urges the user to perform a fixing operation (recognition) for the image input apparatus on the display unit 120 (step S506).

When the user performs the fixing operation for the image input apparatus (step S507), the CPU 111 transmits information that identifies the fixed image input apparatus 1202 to the server 103 by the search script 325 (step S508). Thereby, the search process in the information processing apparatus 1201 is finished.

On the other hand, when determining that the image input apparatus 1202 is not usable (NO in the step S505), the CPU 111 transmits a search request to the server 103 by the search script 325. The CPU 111 broadcasts a response received from the server 103 to the local network 104 by the search script 325, and searches for an image input apparatus. While the search process is executed by the search script 325, the CPU 111 displays the search screen including the message of “IMAGE INPUT APPARATUS IS BEING SEARCHED” as shown in FIG. 11 on the display unit 120 by the search script 325 (step S509).

After the step S509, the CPU 111 determines whether the polling process (see S404) that accepts a response to the search request by the server 103 during the fixed time period has timed out by the search script 325 (step S510). In the step S510, the CPU 111 determines whether the HTML file (see S211) concerning the image-input-apparatus list showing that the search for an image input apparatus is completed is received from the server 103 by the search script 325.

When it does not time out and the image-input-apparatus list concerning the HTML file is not received (NO in the step S510), the CPU 111 returns the process to the step S509. When it times out or the search process for an image input apparatus is canceled (“TIMEOUT” in the S510), the CPU 111 proceeds with the process to the step S514. Since the process in the step S514 has been already described, a description here is omitted.

When the search process for an image input apparatus is completed normally (YES in the step S510), the CPU 111 receives the HTML file (S211 reference) concerning the image-input-apparatus list which shows that search for an image input apparatus is completed from the server 103 by the search script 325. Therefore, the CPU 111 displays the image-input-apparatus list as shown in FIG. 11 on the display unit 120 by the search script 325 (step S511). When the user selects the image input apparatus used from among the image input apparatuses displayed in the image-input-apparatus list (step S512), the CPU 111 notifies the server 103 of a selection result message (see S214) by the search script 325 (step S513). Then, the CPU 111 finishes the search process.

The process equivalent to that in the steps S901 through S909 in FIG. 8 is executed after fixing the image input apparatus used until the image input apparatus used generates image data and transmits it to the server 103. On the other hand, when the image input apparatus 102 is fixed to use, the process equivalent to that in the steps S215 through S230 in FIG. 4 is executed so that the image input apparatus 102 generates image data and transmits it to the server 103.

FIG. 11 shows an example of the search screen (user interface) used for searching for an image input apparatus that is displayed on a display unit 120 of the information processing apparatus 101a (101b, 1201). The search screen 600 is displayed on the display unit 120 when the updated HTML file is received from the server 103, while the search script 325 is running on the web browser 133 currently executed on the RAM 112 of the information processing apparatus 101a (101b, 1201).

When an abort button 601 is pushed by the user, a message that stops the search process for an image input apparatus is transmitted to the server 103 by the search script 325, and thereby, the server 103 stops the search process for an image input apparatus.

FIG. 12 shows an example of the image-input-apparatus list screen that is displayed on the display unit 120 of the information processing apparatus 101. In the step S511 in FIG. 10, the image input control program 326 of the server 103 generates the HTML file concerning the image-input-apparatus list screen, and transmits it to the web browser 133 of the information processing apparatus 1201. The display unit 120 of the information processing apparatus 1201 that receives the HTML file displays the image-input-apparatus list screen 700 as a user interface on which the user selects the image input apparatus 102.

The retrieved image input apparatuses are displayed on a list display area 701. When the user selects a desired image input apparatus and pushes a selection button 702, the search script 325 on the information processing apparatus 1201 transmits the selection result message (see S214) to the server 103. Thereby, the server 103 prepares the scan script 328 corresponding to the selected image input apparatus.

When the user pushes a re-search button 703, the search request (see S204) is again transmitted to the server 103 as a message, and the process in the steps S205 through S212 in FIG. 5 is performed. Thereby, the contents in the list display area 701 of the image-input-apparatus list screen 700 is updated.

FIG. 13 shows an example of the screen displayed on the display unit 120 of the information processing apparatus 101 in order to urge the user to fix an image input apparatus used. In the step S306 in FIG. 7 or the step S506 in FIG. 10, the image input control program 326 of the server 103 generates the HTML file concerning the screen to fix an image input apparatus. The web browser 133 of the information processing apparatus 101a (101b, 1201) displays the screen 800 that urges to fix an image input apparatus used on the display unit 120 when receiving the HTML file.

A text (message) showing that the image input apparatus 1202 of the multifunctional peripheral device 109 is fixed to use is displayed on a viewing window 801. When the user pushes an OK button 802, the image input apparatus 1202 of the multifunctional peripheral device 109 is fixed to use, and the information that identifies the image input apparatus 1202 is notified to the server 103.

According to the embodiment, when the server 103 on the Internet 107 searches for the image input apparatus 102a (102b-1202) on the local network 104, the information processing apparatus 101a (101b-1201) on the local network 104 executes this process by proxy. In this case, when the web browser 133 of the information processing apparatus 101a (101b-1201) executes an application of the server 103 and when an information processing apparatus and an image input apparatus are contained in a single apparatus, the information processing apparatus does not transmit a search packet to the local network 104 wastefully. Thereby, waste of the network resource can be eliminated.

Although the embodiments of the invention have been described, the present invention is not limited to the above-mentioned embodiments, the present invention includes various modifications as long as the concept of the invention is not deviated. The embodiments mentioned above show examples of the present invention, and it is possible to combine the embodiments suitably.

For example, the communication between the server 103 and the image input apparatus 102a (102b, 1202) through the information processing apparatus 101a (101b, 1201) can be executed by any methods, such as the ActiveX control, a Java (registered trademark) script, a Java (registered trademark) applet, and various plug-ins, as long as they are executable by the information processing apparatus 101a (101b, 1201). However, since the server 103 has choices of communication methods and there is a merit when the information processing apparatus 101a (101b, 1201) that does not need many functions is available, the priority among communication methods is determined. That is, it is efficient to use the communication method that can be executed on the information processing apparatus 101a (101b, 1201).

Use of a two-way communication technique, such as the WebSockets (http://dev.w3.org/html5/WebSockets), as a communication method is effective in order to enable a simple and efficient two-way communication. When the technique like the WebSockets is introduced, the search script 325 or the scan script 328 is not required to transmit the update message for the HTML file to the server 103 periodically. The message from the server 103 can be updated without a request from the information processing apparatus 101a (101b, 1201).

The notification of transmission etc. is also feasible by using the protocol defined by WS-Eventing or the GENA (General Event Notification Architecture) etc. The image input system of the present invention can employ any protocols as long as there is another method that gives the hardware information suitably to the search script 325 on the information processing apparatus 101a (101b, 1201) and a similar result is obtained.

In the above-mentioned embodiment, the method of generating the scan job by the information processing apparatus 101a (101b, 1201) and transmitting it to the image input apparatus 102a (102b, 1202) is used in order to generate image data by scanning by the image input apparatus 102a (102b, 1202). The present invention is not restricted to this. When the image input apparatus 102a (102b, 1202) is able to receive a scan job, the method of transmitting general-purpose information like a scan job ticket to the image input apparatus 102a (102b, 1202) may be used.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-123641, filed on Jun. 1, 2011, which is hereby incorporated by reference herein in its entirety.

What is claimed is:

1. An image input system comprising:
a server;
an information processing apparatus configured to communicate with said server via the Internet and a wireless communication network;
a first image input apparatus configured to be directly connected to said information processing apparatus; and
second image input apparatuses configured to be connected to said information processing apparatus via a local network,
wherein said server comprises:
a search message transmission unit configured to transmit a search message for searching an image input apparatus to said information processing apparatus,
wherein said information processing apparatus comprises:
a determination unit configured to determine whether said first image input apparatus is usable in response to reception of the search message from said server; and
a selection unit configured to select said first image input apparatus without searching for said second image input apparatuses and to notify said server of the selection when said determination unit determines that said first image input apparatus is usable.

2. The image input system according to claim 1, wherein said server further comprises an attribution information transmission unit that transmits attribution information about reading of an image to said information processing apparatus,
wherein said information processing apparatus further comprises a profile information acquisition unit configured to acquire profile information about said first image input apparatus, and
wherein said determination unit determines whether said first image input apparatus is usable based on the attribution information and the profile information.

3. The image input system according to claim 1, wherein said information processing apparatus further comprises:
a search unit configured to search for said second image input apparatuses through the local network when said determination unit determines that said first image input apparatus is not usable;
a transfer unit configured to transfer responses transmitted from said second image input apparatuses in response to the search by said search unit to said server; and
a display unit configured to display a list of said second image input apparatuses based on the responses transmitted from said server,
wherein said server further comprises:
a list transmission unit configured to generate the list based on the responses from said second image input apparatuses received from said information processing apparatus, and to transmit the list to said information processing apparatus.

4. An information processing apparatus that communicates with a server via the Internet and a wireless communication network, is directly connected to a first image input apparatus, and is connected to second image input apparatuses through a local network, comprising:
a search message reception unit configured to receive a search message for searching an image input apparatus from the server;
a determination unit configured to determine whether the first image input apparatus is usable in response to reception of the search message; and
a selection unit configured to select the first image input apparatus without searching for said second image input apparatuses and to notify said server of the selection when said determination unit determines that the first image input apparatus is usable.

5. The information processing apparatus according to claim 4, further comprising:
an attribution information reception unit configured to receive attribution information about reading of an image from the server; and
a profile information acquisition unit configured to acquire profile information about the first image input apparatus,
wherein said determination unit determines whether the first image input apparatus is usable based on the attribution information and the profile information.

6. The information processing apparatus according to claim 4, further comprising:
a search unit configured to search for the second image input apparatuses through the local network when said determination unit determines that the first image input apparatus is not usable.

7. The information processing apparatus according to claim 6, further comprising:
a transfer unit configured to transfer responses transmitted from the second image input apparatuses in response to the search by said search unit to the server; and
a display unit configured to display a list of the second image input apparatuses based on the responses transmitted from said server.

8. A control method for an information processing apparatus that communicates with a server via the Internet and a wireless communication network, is directly connected to a first image input apparatus, and is connected to second image input apparatuses through a local network, the control method comprising:
a search message reception step of receiving a search message for searching an image input apparatus from the server;
a determination step of determining whether the first image input apparatus is usable in response to reception of the search message; and
a selection step of selecting the first image input apparatus without searching for the second image input apparatuses and to notify said server of the selection when it is determined that the first image input apparatus is usable in said determination step.

9. A non-transitory computer-readable storage medium storing a control program causing a computer to execute a control method for an information processing apparatus that communicates with a server via the Internet and a wireless communication network, is directly connected to a first image input apparatus, and is connected to second image input apparatuses through a local network, the control method comprising:
a search message reception step of receiving a search message for searching an image input apparatus from the server;
a determination step of determining whether the first image input apparatus is usable in response to reception of the search message; and
a selection step of selecting the first image input apparatus without searching for the second image input apparatuses and to notify said server of the selection when it is determined that the first image input apparatus is usable in said determination step.
